(19) United States
(12) Patent Application Publication
(10) Pub. No.: US 2007/0091022 A1
(43) Pub. Date: Apr. 26, 2007

(54) Plasma display apparatus and method of driving the same

(75) Inventor: Seonghak Moon, Seoul (KR)

Correspondence Address: FLESHNER & KIM, LLP, P.O. BOX 221200, CHANTILLY, VA, 20153, US

(73) Assignee: LG Electronics Inc.

(21) Appl. No.: 11/583,065

(22) Filed: Oct. 19, 2006

(30) Foreign Application Priority Data
Oct. 20, 2005 (KR) 10-2005-0099117

(51) Int. Cl. G09G 3/28

(52) U.S. Cl. 345/67

(57) ABSTRACT

A plasma display apparatus and a method of driving the same are disclosed The plasma display apparatus includes a plasma display panel including a first electrode and a second electrode, a first electrode driver, and a second electrode driver. The first electrode driver supplies a first sustain pulse of a first polarity to the first electrode at a first supply time point. The second electrode driver supplies a second sustain pulse of a second polarity, which overlaps the first sustain pulse, to the second electrode at a second supply time point.

This Nonprovisional application claims priority under 35 U.S.C. § 119(a) on Patent Application No. 10-2005-0099117 filed in Korea on Oct. 20, 2005 the entire contents of which are hereby incorporated by reference.

### BACKGROUND

1. Field

This document relates to a plasma display apparatus and a method of driving the same.

2. Description of the Related Art

A plasma display apparatus comprises a plasma display panel in which a discharge cell is filled with a main discharge gas and an inert gas, and a driver. When a high frequency voltage is supplied to an electrode of the plasma display panel, the inert gas generates vacuum ultraviolet rays, which thereby cause a phosphor formed between bairier ribs of the plasma display panel to emit light.

The plasma display apparatus displays an image during each of subfields constituting a frame. Each of the subfields comprises a reset period for initializing all the discharge cells, an address period for selecting cells to be discharged, and a sustain period for representing gray level in accordance with the number of discharges.

The reset period comprises a setup period and a set-down period. During the setup period, a setup pulse is supplied to scan electrodes. The setup pulse generates a weak dark discharge in the discharge cells. This results in wall charges of a positive polarity being accumulated on address electrodes and sustain electrodes, and wall charges of a negative polarity being accumulated on the scan electrodes.

During the set-down period, a set-down pulse is supplied to the scan electrodes As a result, a portion of the wall charges excessively accumulated on the scan electrodes is erased such that the remaining wall charges are uniform inside the discharge cells.

During the address period, a scan pulse is supplied to the scan electrodes, and a data pulse is supplied to the address electrodes. As the voltage difference between the scan pulse and the data pulse is added to the wall voltage produced during the reset period, the cells to be discharged are selected.

During the sustain period, a sustain pulse is supplied to the scan electrodes and the sustain electrodes. A sustain discharge occurs within the discharge cells selected during the address period, thereby displaying an image.

The driver of the plasma display apparatus supplies a driving pulse to the electrode of the plasma display panel during the reset period, the address period and the sustain period. In other words, the driver supplies the setup pulse and the set-down pulse during the reset period, the data pulse and the scan pulse during the address period, and the sustain pulse during the sustain period.

### SUMMARY OF THE INVENTION

In one aspect a plasma display apparatus comprises a plasma display panel comprising a first electrode and a second electrode, a first electrode driver for supplying a first sustain pulse of a first polarity to the first electrode at a first supply time point, and a second electrode driver for supplying a second sustain pulse of a second polarity, which overlaps the first sustain pulse, to the second electrode at a second supply time point.

In another aspect a method of driving a plasma display apparatus comprising a first electrode, a second electrode, and a third electrode, the method comprises supplying a first sustain pulse of a first polarity to the first electrode at a first supply time point, and supplying a second sustain pulse of a second polarity, which overlaps the first sustain pulse, to the second electrode at a second supply time point.

### BRIEF DESCRIPTION OF THE DRAWINGS

The accompany drawings, which are included to provide a further understanding of the invention and are incorporated in and constitute a part of this specification, illustrate embodiments of the invention and together with the description serve to explain the principles of the invention.

FIG. 1 illustrates a plasma display apparatus according to an embodiment;

FIG. 2 illustrates an example of a driving signal of the plasma display apparatus according to the embodiment;

FIG. 3 illustrates a sustain pulse of the plasma display apparatus according to the embodiment;

FIG. 4 is a cross-sectional view of a plasma display panel; and

FIG. 5 illustrates another example of a driving signal of the plasma display apparatus according to the embodiment.

### DETAILED DESCRIPTION OF PREFERRED EMBODIMENTS

Preferred embodiments of the present invention will be described in a more detailed manner with reference to the drawings.

A plasma display apparatus comprises a plasma display panel comprising a first electrode and a second electrode, a first electrode driver for supplying a first sustain pulse of a first polarity to the first electrode at a first supply time point, and a second electrode driver for supplying a second sustain pulse of a second polarity, which overlaps the first sustain pulse, to the second electrode at a second supply time point.

The second supply time point may be earlier than the first supply time point.

The plasma display apparatus may further comprise a third electrode and a third electrode driver for driving the third electrode. The first electrode driver may supply a reset pulse of a negative polarity, which falls from a first voltage to a second voltage, during a reset period, and the third electrode driver may supply a pulse of a positive polarity, which rises from a third voltage to a fourth voltage, during the reset period.

The fourth voltage level may be substantially equal to the highest voltage level of a data pulse, which the third electrode driver supplies during an address period.

The reset pulse of the negative polarity may comprise a set-down pulse gradually falling to the second voltage.

After the first electrode driver supplies a reset pulse falling from a first voltage to a second voltage, the first electrode driver may supply a supply pulse.

A magnitude of the highest voltage of the supply pulse may be substantially equal to a magnitude of the highest voltage of a sustain pulse.

A polarity of the highest voltage of the supply pulse may be different from a polarity of the lowest voltage of the reset pulse.

The width of the supply pulse maybe less than the width of a sustain pulse.

A time interval between the first supply time point and the second supply time point may be equal to or less than 50% of the width of the first sustain pulse or the width of the second sustain pulse.

A method of driving a plasma display apparatus comprising a first electrode, a second electrode, and a third electrode, the method comprises supplying a first sustain pulse of a first polarity to the first electrode at a first supply time point, and supplying a second sustain pulse of a second polarity, which overlaps the first sustain pulse, to the second electrode at a second supply time point.

The second supply time point may be earlier than the first supply time point.

The method may further comprises supplying a reset pulse of a negative polarity, which falls from a first voltage to a second voltage, to the first electrode during a reset period, and supplying a pulse of a positive polarity, which rises from a third voltage to a fourth voltage, to the third electrode during the reset period.

The fourth voltage level may be substantially equal to the highest voltage level of a data pulse supplied to the third electrode.

The reset pulse of the negative polarity may comprise a set-down pulse gradually falling to the second voltage.

The may further comprises supplying a reset pulse of a negative polarity falling from a first voltage to a second voltage to the first electrode, and supplying a supply pulse to the first electrode.

A magnitude of the highest voltage of the supply pulse may be substantially equal to a magnitude of the highest voltage of a sustain pulse.

A polarity of the highest voltage of the supply pulse may be different from a polarity of the lowest voltage of the reset pulse.

The width of the supply pulse may be less than the width of a sustain pulse.

Hereinafter, exemplary embodiments of the present invention will be described in detail with reference to the attached drawings.

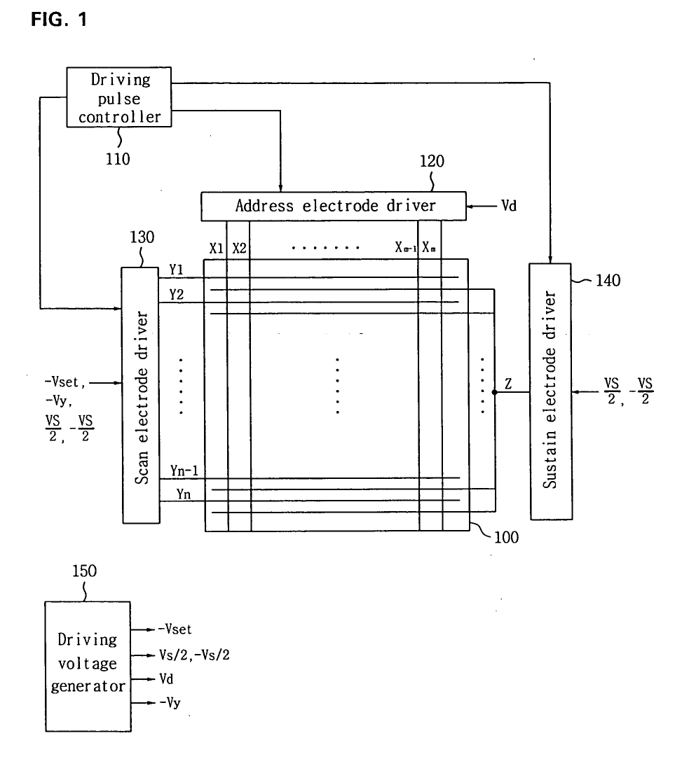

FIG. 1 illustrates a plasma display apparatus according to an embodiment. As illustrated in FIG. 1, the plasma display apparatus according to the embodiment comprises a plasma display panel 100, a driving pulse controller 110, an address electrode driver 120, a scan electrode driver 130, a sustain electrode driver 140, and a driving voltage generator 150.

The plasma display panel 100 comprises scan electrodes Y1 to Yn, sustain electrodes Z, and address electrodes X1 to Xm intersecting the scan electrodes Y1 to Yn and the sustain electrodes Z.

The driving pulse controller 110 outputs a timing control signal for supplying a driving pulse by each of the address electrode driver 120, the scan electrode driver 130, and the sustain electrode driver 140.

The address electrode driver 120 receives the timing control signal from the driving pulse controller 110, and then supplies a data pulse corresponding to a video signal to the address electrodes X1 to Xm formed in the plasma display panel 100. The video signal is supplied to the address electrode driver 120 through a half-toning circuit (not illustrated), a subfield mapping circuit (not illustrated), and a subfield arranging circuit (not illustrated).

The scan electrode driver 130 receives the timing control signal from the driving pulse controller 110, and then supplies a reset pulse, a supply pulse, a scan pulse, and a sustain pulse to the scan electrodes Y1 to Yn. In particular, the scan electrode driver 130 supplies a sustain pulse of a first polarity to the scan electrodes Y1 to Yn at a first supply time point.

The sustain electrode driver 140 receives the timing control signal from the driving pulse controller 110, and then supplies a bias voltage and a sustain pulse to the sustain electrodes Z. In particular, the sustain electrode driver 140 supplies a sustain pulse of a second polarity, which overlaps the sustain pulse of the first polarity, to the sustain electrodes Z at a second supply time point earlier than the first supply time point.

For example, when the scan electrode driver 130 supplies a sustain pulse of a positive polarity, the sustain electrode driver 140 may supply a sustain pulse of a negative polarity to overlap the sustain pulse of the positive polarity. Further, when the scan electrode driver 130 supplies a sustain pulse of a negative polarity, the sustain electrode driver 140 may supply a sustain pulse of a positive polarity to overlap the sustain pulse of the negative polarity.

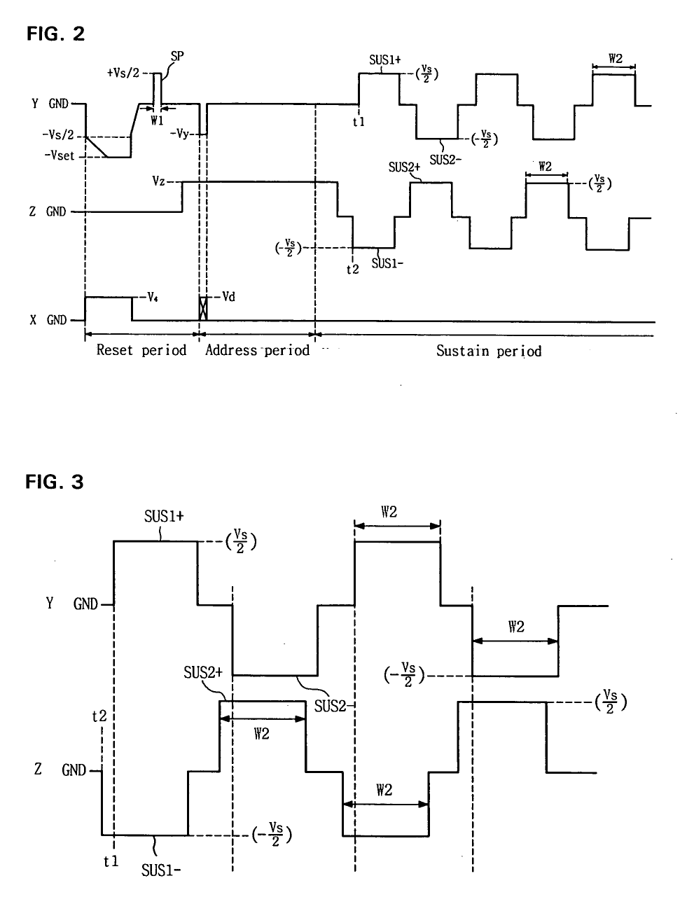

The following is a detailed description of operations of the scan electrode driver 130 and the sustain electrode driver 140, with reference to FIGS. 2 and 3.

The driving voltage generator 150 generates a reset voltage −Vset a scan voltage −Vy, sustain voltages Vs/2 and −Vs/2, a data voltage Vd, and the like. The reset voltage −Vset is equal to the lowest voltage of the reset pulse, and the scan voltage −Vy is equal to the lowest voltage of the scan pulse. The positive sustain voltage Vs/2 is equal to the highest voltage of a sustain pulse of a positive polarity, and the negative sustain voltage −Vs/2 is equal to the lowest voltage of a sustain pulse of a negative polarity.

An operation of the plasma display apparatus according to the embodiment will be described in detail with reference to FIGS. 2 and 3.

FIG. 2 illustrates an example of a driving signal of the plasma display apparatus according to the embodiment.

During a reset period, the scan electrode driver 130 supplies a reset pulse of a negative polarity falling from a ground level voltage GND to the reset voltage −Vset to the scan electrode Y. For example, the scan electrode driver 130 may supplies the reset pulse comprising a set-down pulse, which gradually falls from the negative sustain voltage −Vs/2 to the reset voltage −Vset, to the scan electrode Y.

During the reset period, the address electrode driver 120 supplies a pulse of a positive polarity rising from the ground level voltage GND to a predetermined voltage V4 to the address electrode X. A magnitude of the predetermined voltage V4 which the address electrode driver 120 supplies during the reset period may be equal to a magnitude of the data voltage Vd of the data pulse which the address electrode driver 120 supplies during an address period. When the magnitude of the predetermined voltage V4 is substantially equal to the magnitude of the data voltage Vd of the data pulse, the address electrode driver 120 may have the simple configuration.

As above, when the reset pulse of the negative polarity and the predetermined voltage V4 are supplied during the reset period, a damage to a phosphor caused by positive charges is prevented and wall charges are sufficiently formed in discharge cells of the plasma display panel.

After supplying the reset pulse, the scan electrode driver 130 supplies a supply pulse SP to the scan electrode Y. The address electrode driver 120 and the sustain electrode driver 140 supplies the ground level voltage GND to the address electrode X and the sustain electrode Z during the supplying of the supply pulse SP, respectively. As a result, a predetermined amount of positive charges formed on the scan electrode Y is erased such that the remaining wall charges are uniform to the extent that an addressing operation can be stably performed. To erase the predetermined amount of positive charges, a width W1 of the supply pulse SP may be smaller than a width W2 of the sustain pulse. To simplify the circuit configuration of the scan electrode driver 130, the highest voltage of the supply pulse SP may be substantially equal to the highest voltage of sustain pulses SUS1+ and SUS2+ of a positive polarity.

During the address period, the scan electrode driver 130 sequentially supplies a scan pulse falling to the scan voltage −Vy to each scan electrode Y, and the address electrode driver 120 sequentially supplies a data pulse, synchronized with the scan pulse, rising to the data voltage Vd to each address electrode X. This results in the selection of a discharge cell where a sustain discharge will occur during a sustain period. The sustain electrode driver 140 supplies a bias voltage Vz to the sustain electrode Z during the address period such that an opposite discharge between the scan electrode Y and the address electrode X occur smoothly.

After completing the addressing of the discharge cell, the scan electrode driver 130 and the sustain electrode driver 140 supplies the sustain pulse of the positive polarity or the negative polarity.

FIG. 3 illustrates a sustain pulse of the plasma display apparatus according to the embodiment.

The scan electrode driver 130 supplies a sustain pulse SUS1+ of a positive polarity at a first supply time point t1 of the sustain period, and the sustain electrode driver 140 supplies a sustain pulse SUS1− of a negative polarity at a second supply time point t2 earlier than the first supply time point t1. The sustain electrode driver 140 supplies the sustain pulse SUS1− of the negative polarity to overlap the sustain pulse SUS1+ of the positive polarity. Since the sustain pulse SUS1+ of the positive polarity and the sustain pulse SUS1− of the negative polarity are supplied to the scan electrode Y and the sustain electrode Y, respectively, a voltage difference between the scan electrode Y and the sustain electrode Y is equal to a voltage vs. Accordingly, the sustain discharge occurs in the discharge cell selected during the address period.

The scan electrode driver 130 supplies a sustain pulse SUS2− of a negative polarity, and the sustain electrode driver 140 supplies a sustain pulse SUS2+ of a positive polarity during the sustain period. The sustain electrode driver 140 supplies the sustain pulse SUS2+ of the positive polarity to overlap the sustain pulse SUS2− of the negative polarity. Since the sustain pulse SUS2− of the negative polarity and the sustain pulse SUS2+ of the positive polarity are supplied to the scan electrode Y and the sustain electrode Y, respectively, a voltage difference between the scan electrode Y and the sustain electrode Y is equal to the voltage vs. Accordingly, the sustain discharge occurs in the discharge cell selected during the address period. A supply time point of the sustain pulse SUS2+ of the positive polarity is earlier than a supply time point of the sustain pulse SUS2− of the negative polarity.

As above, since the sustain pulse of the positive polarity and the sustain pulse of the negative polarity overlap each other, the electric field distribution between the scan electrode Y and the sustain electrode Y is uniform. In other words, when a sustain pulse is alternately supplied to the scan electrode or the sustain electrode, an electric filed are formed around the scan electrode or the sustain electrode. On the other hand, when the sustain pulse of the positive polarity and the sustain pulse of the negative polarity, which overlap each other, are supplied to the scan electrode Y and the sustain electrode Z, the electric field distribution between the scan electrode Y and the sustain electrode Z is uniform. This results in the generation of the stable sustain discharge.

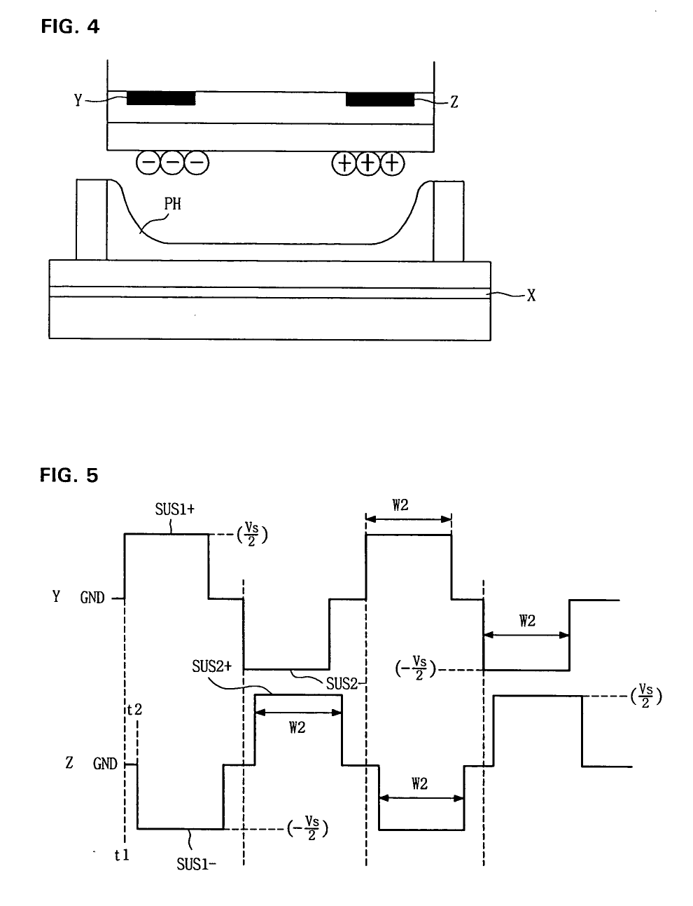

Since the sustain pulse of the negative polarity is supplied when supplying the sustain pulse of the positive polarity, the positive charges are formed on the scan electrode Y or the sustain electrode Z. Therefore, there is small likelihood that the positive charges will collide with the phosphor. For example, as illustrated in FIG. 4, when the sustain pulse of the positive polarity is supplied to the scan electrode Y and the sustain pulse of the negative polarity is supplied to the sustain electrode Z, negative charges are formed on the scan electrode Y and positive charges are formed on the sustain electrode Z. Therefore, there is small likelihood that the positive charges will collide with a phosphor PH. As a result, a damage to the phosphor decreases and a change in a return property of the phosphor is prevented. In other words, the phosphor is excited by vacuum ultraviolet rays emitted using an inert gas and then is returned to an original state, thereby emitting visible light. In a case where the positive charges collide with the phosphor such that the phosphor is degraded, a property of the excitation and the return of the phosphor is changed. Therefore, the image quality becomes worse. However, since the sustain pulse of the negative polarity is supplied when supplying the sustain pulse of the positive polarity in the embodiment, there is small likelihood that the positive charges will degrade the phosphor. This results in the prevention of the change in the return property of the phosphor.

As illustrated FIG. 3, since the supplying of the sustain pulses SUS1− and SUS2+ to the sustain electrode Z is performed earlier than the supplying of the sustain pulses SUS1+ and SUS2− to the scan electrode Y, the amount of space charges in the discharge cell increases. For example, a voltage −Vs/2 is supplied to the sustain electrode Z and the ground level voltage GND is supplied to the scan electrode Y between the start time point t2 (i.e., the second time point t2) of the supplying of the sustain pulse SUS1− of the negative polarity to the sustain electrode Z and the start time point t1 (i.e, the first time point t2) of the supplying of the sustain pulse SUS1+ of the positive polarity to the scan electrode Y. Accordingly, the amount of negative charges in a space inside the discharge cell increases. Since the sustain pulse SUS1+ of the positive polarity and the sustain pulse SUS1− of the negative polarity overlap each other after a predetermined time interval from the time point t2, the amount of charges contributing to the sustain discharge increases and the electric field distribution between the scan electrode Y and the sustain electrode Z is uniform. Accordingly, a charge in the return property of the phosphor is prevented, and the efficiency of the sustain discharge increases.

The predetermine time interval between the first supply time point t1 and the second supply time point t2 may be equal to or less than 50% of the width W2 of the sustain pulse of the positive polarity or the width W2 of the sustain pulse of the negative polarity. In such a case, the sustain discharge is stably performed, a charge in the return property of the phosphor is prevented, and the efficiency of the sustain discharge increases.

FIG. 5 illustrates another example of a driving signal of the plasma display apparatus acceding to the embodiment. FIG. 3 illustrates that the supplying of the sustain pulses SUS1− and SUS2+ to the sustain electrode Z is performed earlier than the supplying of the sustain pulses SUS1+ and SUS2− to the scan electrode Y. However, as illustrated in FIG. 5, the supplying of the sustain pulses SUS1+ and SUS2− to the scan electrode Y may be performed earlier than the supplying of the sustain pulses SUS1− and SUS2+ to the sustain electrode Z. For example, since the ground level voltage GND is supplied to the sustain electrode Z when supplying the sustain pulses SUS1+ of the positive polarity to the scan electrode Y, the amount of negative charge in a space inside the discharge cell increases Since the sustain pulse SUSl30 of the positive polarity and the sustain pulse SUS1− of the negative polarity overlap each other after the time point t1, the amount of charges contributing to the sustain discharge increases and the electric field distribution between the scan electrode Y and the sustain electrode Z is uniform. Accordingly, a charge in the return property of the phosphor is prevented, and the efficiency of the sustain discharge increases.

The foregoing embodiments and advantages are merely exemplary and are not to be construed as limiting the present invention. The present teaching can be readily applied to other types of apparatuses. The description of the foregoing embodiments is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures. Moreover, unless the term “means ” is explicitly recited in a limitation of the claims, such limitation is not intended to be interpreted under 35 USC 112(6).

What is claimed is:

1. A plasma display apparatus comprising:
a plasma display panel comprising a first electrode and a second electrode;
a first electrode driver for supplying a first sustain pulse of a first polarity to the first electrode at a first supply time point; and
a second electrode driver for supplying a second sustain pulse of a second polarity, which overlaps the first sustain pulse, to the second electrode at a second supply time point.

2. The plasma display apparatus of claim 1, wherein the second supply time point is earlier than the first supply time point.

3. The plasma display apparatus of claim 1, further comprising a third electrode and a third electrode driver for driving the third electrode,
wherein the first electrode driver supplies a reset pulse of a negative polarity, which falls from a first voltage to a second voltage, during a reset period, and
the third electrode driver supplies a pulse of a positive polarity, which rises from a third voltage to a fourth voltage, during the reset period.

4. The plasma display apparatus of claim 3, wherein the fourth voltage level is substantially equal to the highest voltage level of a data pulse, which the third electrode driver supplies during an address period.

5. The plasma display apparatus of claim 3, wherein the reset pulse of the negative polarity comprises a set-down pulse gradually falling to the second voltage.

6. The plasma display apparatus of claim 1, wherein after the first electrode driver supplies a reset pulse falling from a first voltage to a second voltage, the first electrode driver supplies a supply pulse.

7. The plasma display apparatus of claim 6, wherein a magnitude of the highest voltage of the supply pulse is substantially equal to a magnitude of the highest voltage of a sustain pulse.

8. The plasma display apparatus of claim 6, wherein a polarity of the highest voltage of the supply pulse is different from a polarity of the lowest voltage of the reset pulse.

9. The plasma display apparatus of claim 6, wherein the width of the supply pulse is less than the width of a sustain pulse.

10. The plasma display apparatus of claim 1, wherein a time interval between the first supply time point and the second supply time point is equal to or less than 50% of the width of the first sustain pulse or the width of the second sustain pulse.

11. A method of driving a plasma display apparatus comprising a first electrode, a second electrode, and a third electrode, the method comprising:
supplying a first sustain pulse of a first polarity to the first electrode at a first supply time point; and
supplying a second sustain pulse of a second polarity, which overlaps the first sustain pulse, to the second electrode at a second supply time point.

12. The method of claim 11, wherein the second supply time point is earlier than the first supply time point.

13. The method of claim 11, further comprising supplying a reset pulse of a negative polarity, which falls from a first voltage to a second voltage, to the first electrode during a reset period; and
supplying a pulse of a positive polarity, which rises from a third voltage to a fourth voltage, to the third electrode during the reset period.

14. The method of claim 13, wherein the fourth voltage level is substantially equal to the highest voltage level of a data pulse supplied to the third electrode.

15. The method of claim 13, wherein the reset pulse of the negative polarity comprises a set-down pulse gradually falling to the second voltage.

16. The method of claim 11, further comprising supplying a reset pulse of a negative polarity falling from a first voltage to a second voltage to the first electrode; and
supplying a supply pulse to the first electrode.

17. The method of claim 16, wherein a magnitude of the highest voltage of the supply pulse is substantially equal to a magnitude of the highest voltage of a sustain pulse.

18. The method of claim 16, wherein a polarity of the highest voltage of the supply pulse is different from a polarity of the lowest voltage of the reset pulse.

19. The method of claim 16, wherein the width of the supply pulse is less than the width of a sustain pulse.
